(19) United States
(12) Patent Application Publication
(10) Pub. No.: US 2004/0207803 A1
(43) Pub. Date: Oct. 21, 2004

(54) Device to aid the self-administration of eye drops

(76) Inventor: Edward J. Paukovits JR., Hummelstown, PA (US)

Correspondence Address: DUANE MORRIS LLP, P. O. BOX 1003, 305 NORTH FRONT STREET, 5TH FLOOR, HARRISBURG, PA, 17108-1003, US

(21) Appl. No.: 10/367,037

(22) Filed: Apr. 18, 2003

(51) Int. Cl. G02C 1/00; G02C 9/00

(52) U.S. Cl. 351/47

(57) ABSTRACT

An apparatus is provided for positioning an eye drop container adjacent to an eye having a frame with at least one guide that is positionable adjacent to a persons eye. A socket housing is mounted to the guide to be slidable relative to the eye. The socket housing provides a receptacle for receiving a container-port housing that includes a plug with a bore so that a portion of an eye drop container may be releasably positioned in the bore. When the plug is received within the receptacle, a dispensing nozzle portion of the eye drop container is positioned adjacent to the eye. A kit is also provided for forming multiple apparatus for positioning an eye drop container adjacent to an eye. The kit includes a frame and at least one socket housing that is mounted to a guide on the frame. The socket housing provides a receptacle for that is sized so as to releasably receive a portion of a selected eye drop container. A system is provided for positioning an eye drop container adjacent to an eye. A frame is provided having at least one guide and at least one socket housing mounted to a guide. Each socket housing provides a receptacle for receiving an eye drop container having a nozzle at one end and a frusto-conical annular shoulder that projects radially outwardly from a lower portion of the nozzle. In this way, when the frusto-conical annular shoulder of the eye drop container is received within the receptacle, a portion of the nozzle is positioned adjacent to the eye.

### FIELD OF THE INVENTION

The present invention generally relates to an apparatus associated with the application of eye drops, and more particularly to a device which aids in the self-administration of eye drops.

### BACKGROUND OF THE INVENTION

Illnesses of the eye, such as glaucoma, keratoconjunctivitis (“dry eyes”), infections of the eye, and other conditions are often treated with eye drops. The elderly and the infirm often have difficulty administering eye drops to themselves. This results in a significant amount of often expensive eye medication being spilled during each application.

The self-administering process involves raising an eye drop container above one's eye, taking aim over the eye, and squeezing the container a certain number of times (as prescribed) to dispense the eye drop solution. If the first drop misses the eye, the person must adjust their position to take better aim for the second drop. This results in wasted medication. Moreover, if the user does not realize that the first drop misses or becomes frustrated with repeated misses, inadequate treatment and significant waste of medication results.

Several devices for aiding in the self-administration of eye drops have been provided in the past. For example, U.S. Pat. Nos. 5,836,927; 5,255,024; 4,468,103; 4,183,355; and 3,446,209 all disclose eye drop apparatii which are designed to aid in the self administration of eye drops. These devices have had some disadvantages.

U.S. Pat. No. 5,836,927, provides a device that has solved many of the problems in the art. It discloses a device for administering a liquid eye drop from an eye drop container to an eye of a user that comprises an eyeglass frame with an upper bridge portion and at least one eye drop guide attached to the eyeglass frame. The eye drop guide is vertically adjustable in a substantially arcuate fashion, preferably from a position located proximate the lower portion of a user's eye to a position located near the upper portion of a user's eye. Advantageously, the eye drop guide and the eye drop container are positionable over the conjunctival sac near the center of the arcuate path. The conjunctival sac is typically considered the optimum point to administer an eye drop according to ophthalmologically accepted protocol. The eye drop container is releasably attached to the eye drop guide and the eyeglass frame is secured proximate the eye of the user, e.g. by two ear pieces, a strap or a band.

Unfortunately, the foregoing device still requires the user to assemble their eye drop medication containers to the assembled structure of the invention. This can be very time consuming and prone to difficulties when more than one container, i.e., more than one medication, is needed by the person. Additionally, the eye drop containers may have differing thread types that require further modification of the device between each application of a particular eye drop prescription in a single session. Also, once the foregoing eye drop guide and eye drop bottle are attached to the frame, a special stand is required to prevent leakage from the bottle during storage.

It would therefore be desirable to provide an eye drop application system which can overcome the disadvantages known in the field, and provide a device which allows a user to accurately aim a variety of eye drop containers over their eye and manipulate their eye prior to self-administration thus reducing the significant waste of medication and time inherent with the overall eye drop self-administration process.

### SUMMARY OF THE INVENTION

The present invention provides an apparatus for positioning an eye drop container adjacent to an eye that comprises a frame having at least one guide that is positionable adjacent to a persons eye. A socket housing is mounted to the guide so as to be slidable relative to the eye of a user. The socket housing provides a receptacle for receiving a container-port housing. The container port housing includes a plug with a bore therethrough so that a portion of an eye drop container may be releasably positioned in the bore, e.g., via threads, so that when the plug is received within the receptacle, a dispensing nozzle portion of the eye drop container is positioned adjacent to the eye.

In another embodiment of the invention, a kit is provided for forming multiple apparatus for positioning an eye drop container adjacent to an eye. The kit includes a frame having at least one guide that is positionable adjacent to a persons eye and at least one socket housing that is mounted to each guide so as to be slidable relative to the eye of a user. The socket housing provides a receptacle for receiving one of a plurality of container-port housings, each having a plug with a bore therethrough. Advantageously, the bore in each plug is sized so as to releasably receive a portion of a selected eye drop container so that when the plug is received within the receptacle, a dispensing nozzle portion of the eye drop container is positioned adjacent to the eye.

In yet a further embodiment of the invention, a system is provided for positioning an eye drop container adjacent to an eye. A frame is provided having at least one guide that is positionable adjacent to a persons eye. At least one socket housing is mounted to a guide so as to be slidable relative to the eye of a user. Each socket housing provides a receptacle for receiving an eye drop container having a nozzle at one end and a frusto-conical annular shoulder that projects radially outwardly from a lower portion of the nozzle. In this way, when the frusto-conical annular shoulder of the eye drop container is received within the receptacle, a portion of the nozzle is positioned adjacent to the eye.

### BRIEF DESCRIPTION OF THE DRAWINGS

These and other features and advantages of the present invention will be more fully disclosed in, or rendered obvious by, the following detailed description of the preferred embodiments of the invention, which are to be considered together with the accompanying drawings wherein like numbers refer to like parts and further wherein:

FIG. 1 is a perspective view of a device to aid the self-administration of eye drops according to the present invention;

FIG. 2 is a broken-way, exploded perspective view of an adjustable slide assembly formed in accordance with one embodiment of the present invention;

FIG. 3 is a cross-sectional view of the adjustable slide assembly as taken along line 3-3 in FIG. 2;

FIG. 4 is a perspective view, similar to that shown in FIG. 1, but with a container-port housing exploded away from an eye drop container for clarity of illustration;

FIG. 5 is a perspective view, similar to FIG. 4, but with the container-port housing assembled to the eye drop container;

FIG. 6 is a partially cross-sectioned, elevational view of an adjustable slide assembly and eye drop container arranged in accordance with the present invention;

FIG. 7 is a cross-sectioned, elevational view, similar to FIG. 6, but with the eye drop container and container-port housing extracted from a socket housing;

FIG. 8 is an elevational view of the device of the present invention positioned on a person's face;

FIG. 9 is a side elevational view, similar to FIG. 8, illustrating the adjustability of the present invention;

FIG. 10 is a perspective, exploded view of an eye drop container having a container-port housing assembled to it's dispensing nozzle and a storage cap positioned above the nozzle;

FIG. 11 is a perspective view, similar to FIG. 10, but with the storage cap assembled to the container-port housing;

FIG. 12 is a cross-sectional view of an eye drop container having a container-port housing and a storage cap assembled to it's dispensing nozzle, as taken along lines 12-12 of FIG. 11;

FIG. 13 is an exploded perspective view, similar to that shown in FIG. 12, illustrating an eyedropper container having an integral container-port housing;

FIG. 14 is a perspective view, similar to FIG. 11, of an eye drop container having integrally formed container-port housing with a storage cap assembled to it's dispensing nozzle;

FIG. 15 is a cross-sectional view, as taken along lines 15- 15 in FIG. 14, of an eye drop container having an integral container-port housing with a storage cap assembled to it;

FIG. 16 is a perspective view of a kit formed in accordance with the present invention;

FIG. 17 is a perspective view of a container-port housing formed in accordance with an alternative embodiment of the present invention;

FIG. 18 is a cross-sectional view of the container-port housing shown in FIG. 17, as taken along lines 18-18 in FIG. 17;

FIGS. 19 and 20 are perspective views of further alternative embodiments of container-port housings formed in accordance with the present invention;

FIG. 21 is an exploded perspective view of a container-port housing and non-round eye drop container;

FIG. 22 is an exploded perspective view of an eye drop container having a container-port housing assembled to it's dispensing nozzle and a storage cap positioned above the nozzle, in accordance with an alternative embodiment of the invention;

FIG. 23 is a perspective view, similar to FIG. 22, but with the storage cap assembled to the container-port housing;

FIG. 24 is a cross-sectional view of an eye drop container having a container-port housing and a storage cap assembled to it's dispensing nozzle, as taken along lines 24-24 in FIG. 23;

FIG. 25 is an exploded perspective view, similar to that shown in FIG. 22, illustrating an eye drop container having a threaded nozzle;

FIG. 26 is a perspective view, similar to FIG. 25, of an eye drop container having an integrally formed container-port housing with a storage cap threaded to a nozzle; and

FIG. 27 is a cross-sectional view, as taken along lines 27-27 in FIG. 26, of an eye drop container having an integral container-port housing with a storage cap threaded to the nozzle of the eye drop container.

### DETAILED DESCRIPTION OF THE PREFERRED EMBODIMENT

This description of preferred embodiments is intended to be read in connection with the accompanying drawings, which are to be considered part of the entire written description of this invention. The drawing figures are not necessarily to scale and certain features of the invention may be shown exaggerated in scale or in somewhat schematic form in the interest of clarity and conciseness. In the description, relative terms such as “horizontal,” “vertical,” “up,” “down,” “top” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship. In the claims, means-plus function clauses are intended to cover the structures described, suggested, or rendered obvious by the written description or drawings for performing the recited function, including not only structural equivalents but also equivalent structures.

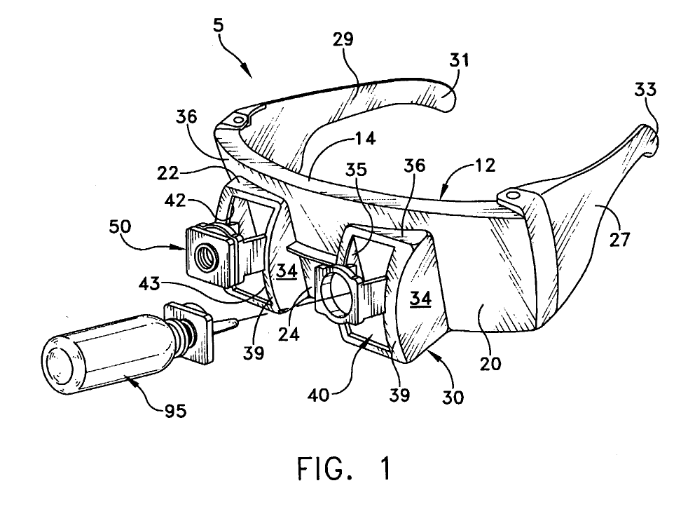

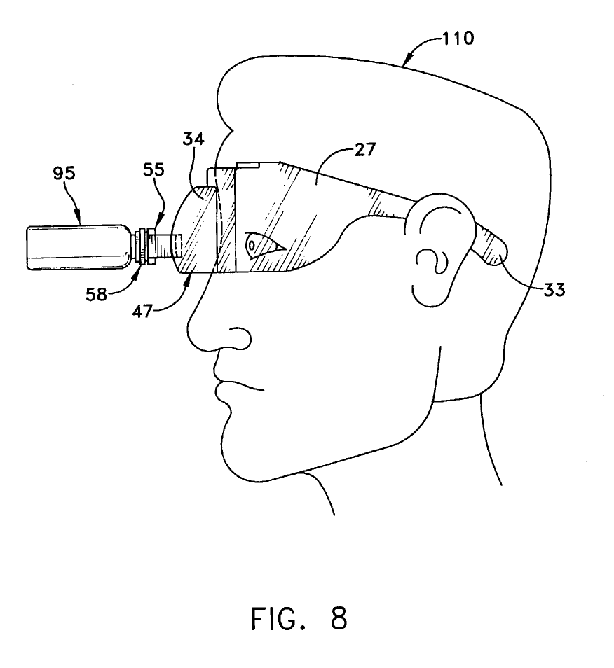

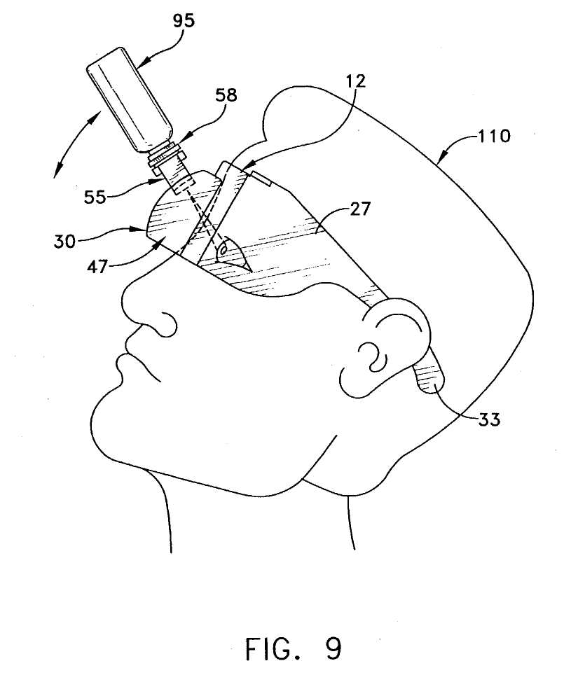

Referring to FIG. 1, an improved device 5 for aiding in the self-administration of eye drops according to one embodiment of the present invention comprises an eyeglass-type frame 12 having a bridge portion 14, two rearwardly extending temple portions 27, 29, that are attached to opposite sides of bridge 14, a shield portion that is divided by a nose rest 24 into a left shield 20 and a right shield 22, and at least one eye drop guide 30. Eye drop guides 30 may be attached (either fixedly or releasably) to each shield portion 20, 22 above a user's left and right eyes, respectively. Temple portions 27, 29 are preferably attached to the outermost ends of bridge portion 14, and extend rearwardly therefrom. Ear pieces 31 and 33 are attached to the end of each temple portion 29, 27, respectively, and depend in a downward direction around the right and left ears of a user for securing device 5 on the head of the user (seen best in FIGS. 8 and 9). Ear pieces 31 and 33 allow the user to orient their head in various positions for eye drop administering purposes without device 5 slipping or falling from its desired position.

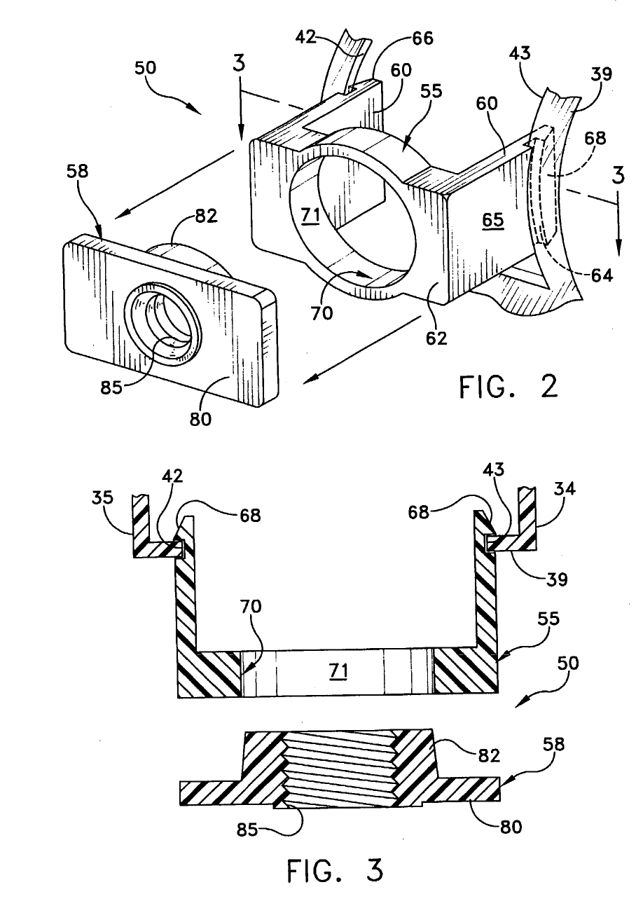

Each eye drop guide 30 comprises left and right sidewalls 34 and 35, and a top portion 36 all of which project outwardly from shields 20, 22, respectively. Eye drop guides 30 may be fixedly or releasably attached to eyeglass frame 12 or, preferably, to one or both sides of shields 20, 22. A frontal plate 39 which, together with sidewalls 34,35 and top portion 36, defines an inner cavity 40. Sidewalls 34 and 35 are both dimensioned so that their outermost edges are curved. Frontal plate 39 is integral with sidewalls 34, 35 so that it has a convex curvature, with edges 42 and 43 arranged in opposed, parallel relation to one another (FIGS. 2 and 3).

Inner cavity 40 is defined by sidewalls 34 and 35, top portion 36, and frontal plate 39, so that a lower opening 47 (FIG. 8) is provided below eye drop guide 30. Preferably, lower opening 47 is sized and shaped to allow the finger of a user to have access into and under the lower portion of eye drop guide 30 in order to manipulate the user's eyelid (e.g., exposing the cunjunctival sac) prior to administration of the eye drops, thereby increasing the odds of successful dispersement of the eye drop solution.

Referring to FIGS. 1-5, an adjustable slide assembly 50 is releasably and slidingly mounted on at least one eye drop guide 30, and comprises a moveable socket housing 55 and a container-port housing 58. More particularly, socket housing 55 includes a pair of spaced-apart cantilevered arms 60 that project outwardly from an interface plate 62. Each cantilevered arm 60 comprises a guide slot 64 defined on an outer surface 65 of its free end 66. Each guide slot 64 is curved so as to be complementary to the curvature of frontal plate 39 and edges 42 and 43. A chamfered surface 68 is formed on the portion of outer surface 65 that extends from each guide slot 64 to each free end 66. A central through-bore 70 is defined in interface plate 62 so as to form a receptacle. The internal surface 71 of interface plate 62 that defines through-bore 70 may be cylindrical or frusto-conical.

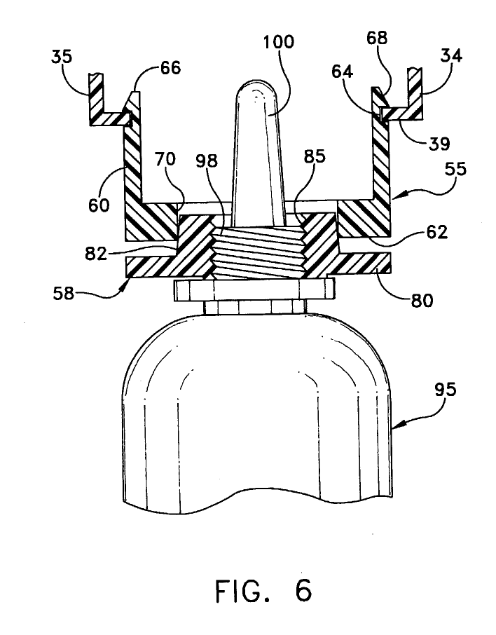

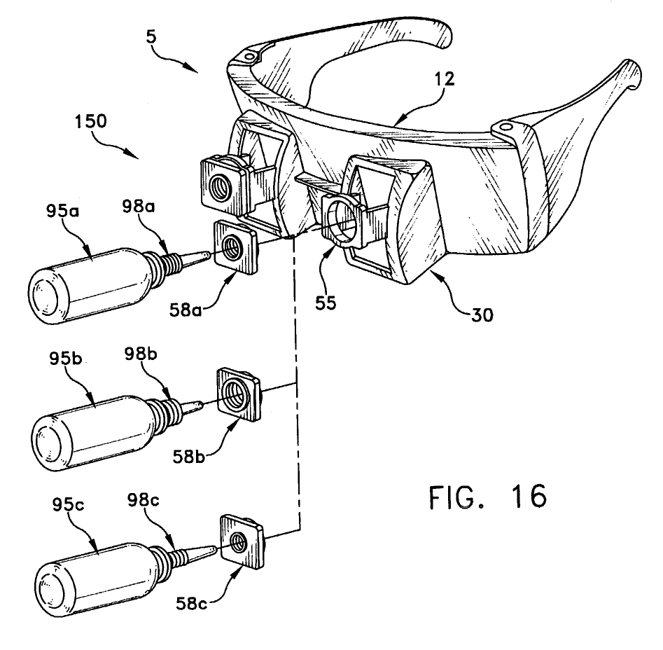

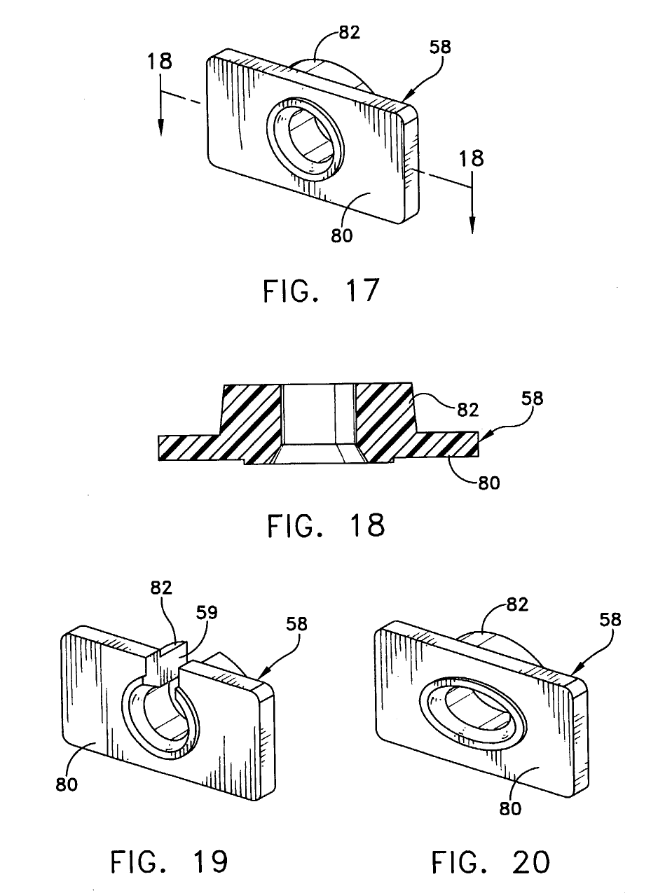

Container-port housing 58 includes a flange 80 and a plug 82. Flange 80 is often a rectangular plate, although other profiles would also be acceptable. A through-bore 85 is defined through the central portion of flange 80. Plug 82 projects outwardly from a surface of flange 80, and comprises a frusto-conical cross-sectional shape (FIG. 3). Through-bore 85 may or may not be threaded, but extends the length of plug 82, and is dimensioned to releasably engage an eye drop container 95 in a secure manner (see FIGS. 1, 4-5, and 17-20). In some non-threaded forms of container-port housing 58, through-bore 85 may also be non-circular (FIG. 20). Often, eye drop container 95 comprises a threaded neck 98 adjacent to a dispensing nozzle 100. Through-bore 85 is correspondingly threaded with this construction. In this way, flange 80 may be threadingly secured to eye drop container 95 through the rotational engagement of threaded neck 98 with threaded through-bore 85 (FIG. 6). In some cases, it may be desirable for eye drop container 95 to engage container-port housing 58 in a snap-fit or friction-fit manner. Additionally, container-port housing 58 may comprise a through-slot 59 (FIG. 19).

Referring to FIGS. 2, 4 and 5, a socket housing 55 may be assembled to each eye drop guide 30 by first orienting cantilevered arms 60 so as to extend toward frontal plate 39. Once in this position, socket housing 55 is moved toward frontal plate 39 so that chamfered surfaces 68, at free ends 66 of cantilevered arms 60, engage edges 42,43 of frontal plate 39, respectively. As chamfered surfaces 68 engage edges 42,43, cantilevered arms 60 are caused to deflect inwardly, toward one another as socket housing 55 continues toward frame 12. Once edges 42,43 encounter guide slots 64, cantilevered arms 60 spring outwardly, away from one another, so as to receive edges 42,43 of frontal plate 39. In this way, socket housing 55 is slidably mounted to eye drop guide 30 since guide slots 64 are curved in a complementary manner with frontal plate 39. It will be understood that surface features may be positioned within guide slot 64 and/or edges 42,43 or frontal plate 39 so that socket housing 55 may be selectively moved along the arc of frontal plate 39. Socket housing 55 is moveable along edges 42, 43 in a substantially arcuate manner above the user's eye generally from a point beneath the user's eye to a point closer to the bridge portion 14. Although the various figures show frontal plate 39 having a radius of curvature generally shaped towards eyeglass shield 20, in some cases it may be desirable to have sidewalls 34, 35 and top portion 36 all extend equally from shield 20 with frontal plate 39 formed flat (i.e., no radius of curvature).

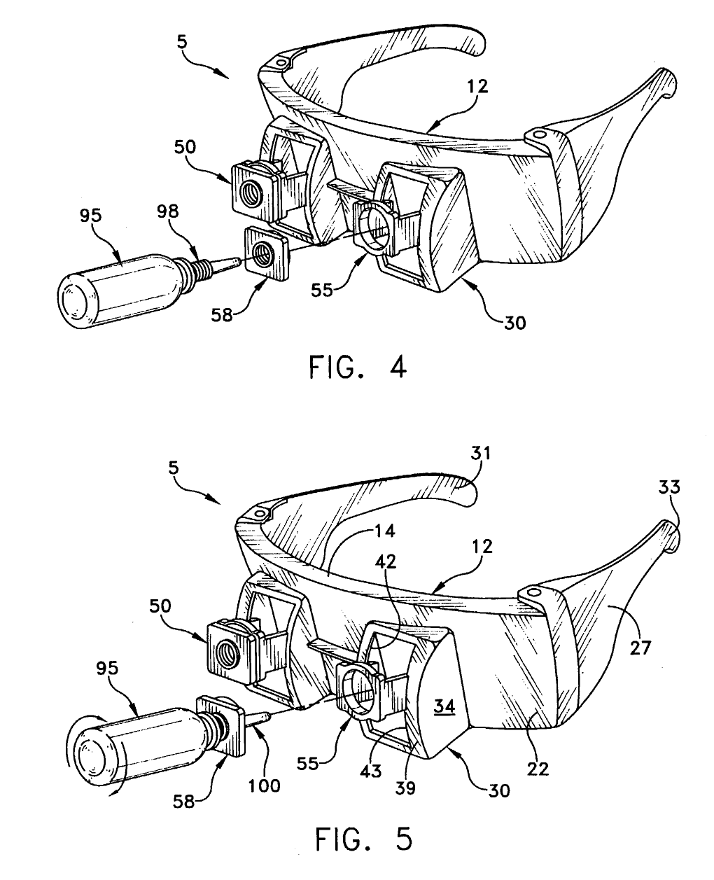

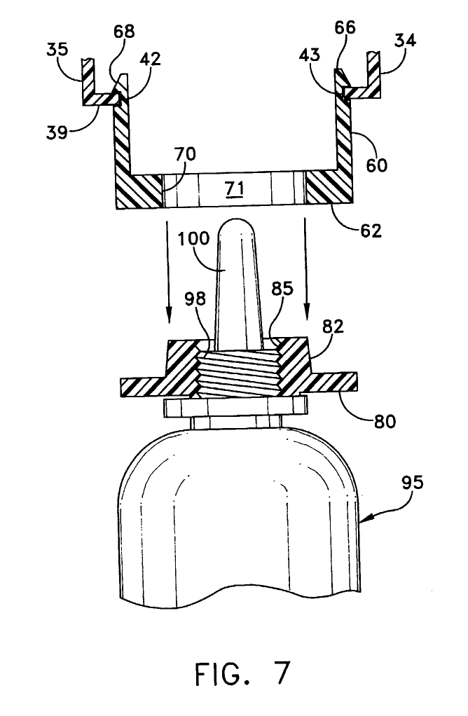

Referring to FIGS. 4-7, container-port housing 58 is assembled to eye drop container 95 by first positioning threaded through-bore 85 in coaxially aligned, spaced relation to nozzle 100. Once in this position, container-port housing 58 is moved toward container 95 so that nozzle 100 enters threaded through-bore 85 until thread 98 engages the threaded internal surface of through-bore 85. Once in this position, either container 95 or container-port housing 58 are rotated so as to threadingly engage container-port housing 58 with container 95. Advantageously, a plurality of container-port housings 58 may be formed, with varying pitch and diameter threaded through-bore 85, so as to accommodate a wide variety of threaded portions 98 on different eye drop containers 95.

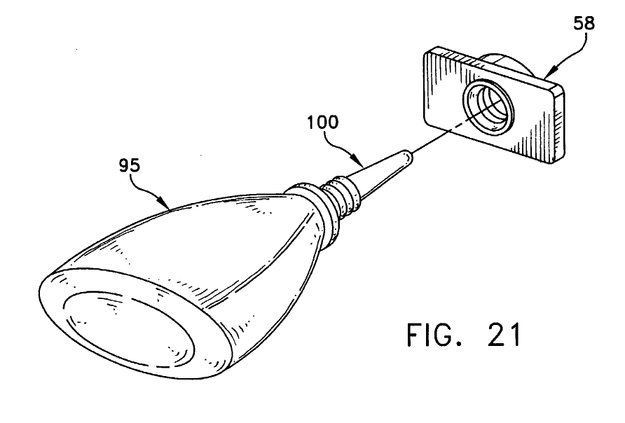

With container-port housing 58 fully assembled to an eye drop container 95, adjustable slide assembly 50 may be fully arranged on eye drop guides 30 by first positioning plug 82 in confronting coaxial relation with through-bore 70 of socket housing 55. Once in this position, eye drop container 95 is moved toward interface plate 62 so that plug 82 enters through-bore 70. The frusto-conical profile of plug 82 allows for a press-fit engagement between container-port housing 58 and socket housing 55. This press fit can be further enhanced by forming internal surface 71 of through-bore 70 with a complementary frusto-conical shape. Of course, once eye drops have been administered, eye drop container 95 may be removed from eye drop guides 30 by simply reversing the foregoing process. It will also be understood that eyedrop container 95 may take various forms and profiles (FIG. 21), without departing from the scope of the present invention.

Referring to FIGS. 8 and 9, during administration a user can easily manipulate the lower portion of his/her eye or eyelid to expose the conjunctival sac which is typically considered to be the ideal area for administering eye drop solution to the eye. When nozzle 100 of container 95 is positioned in eye drop guide 30 by adjustable slide assembly 50, device 5 is placed onto the head of a user 110 in the same manner as a typical pair of glasses. Ideally, device 5 is pushed back against the user's forehead firmly into position on nose bridge 24. The user then tilts his/her head back until the eye drop container 95 is approximately vertical and using his/her finger exposes the lower portion of his/her eye or eyelid through lower opening 47 of eye drop guide 30. The user then adjusts eye drop container 95 over his/her eye and squeezes a prescribed number of times. Alternatively, user 110 can adjust slide assembly 50 prior to placing device 5 onto his/her head. Once an ideal eye drop point is determined, user 110 can mark this position on eye drop guide 30 along the arcuate path so as to repeatably insure successful administration. Advantageously, a guide lock (not shown) may be incorporated on device 5 so that adjustable slide assembly 50 may be selectively secured at an individual user's ideal drop position.

Once the appropriate eye medication has been administered, and eye drop container 95 has been removed from eye drop guide 30, a storage cap 115 may be positioned over nozzle 100. More particularly, storage cap 115 comprises a skirt 118 and a receptacle 120. Skirt 118 is positioned at an open end of receptacle 120, and is sized and shaped to complementarily engage frusto-conical plug 82 of container-port housing 58. Storage cap 115 is mounted to container 95 and container-port housing 58 by orienting receptacle 120 so as to be in coaxial confronting relation to nozzle 100. Once in this position, storage cap 115 is moved toward eye drop container 95 so that nozzle 100 is received within receptacle 120 and skirt 118 slips over and engages plug 82 (FIG. 12). Once in this position, eye drop container 95 may be properly stored in a medicine cabinet or refrigerator, as needed, without fear of contamination or spillage from container 95.

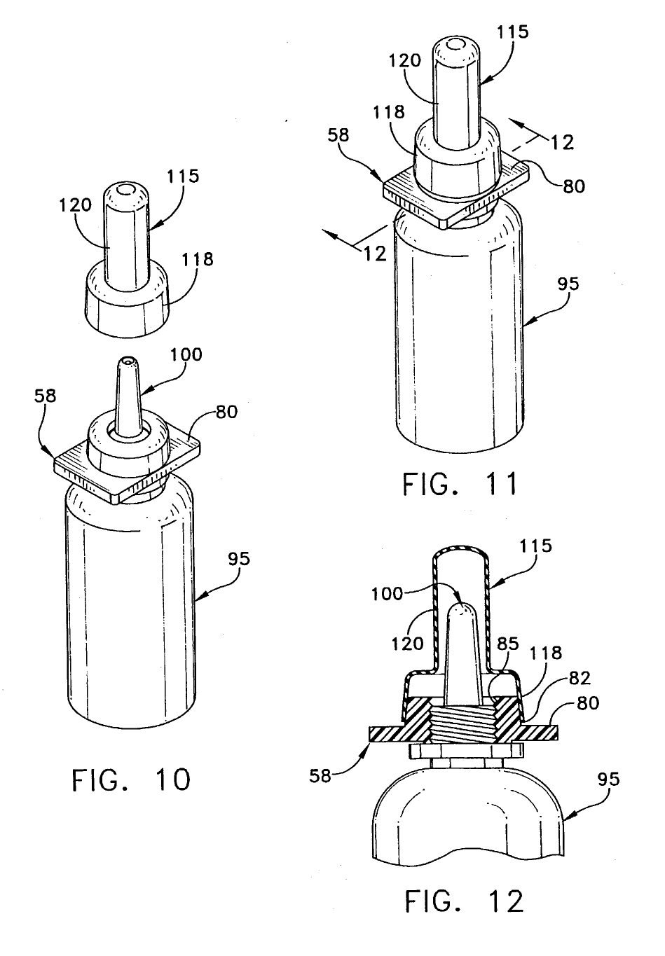

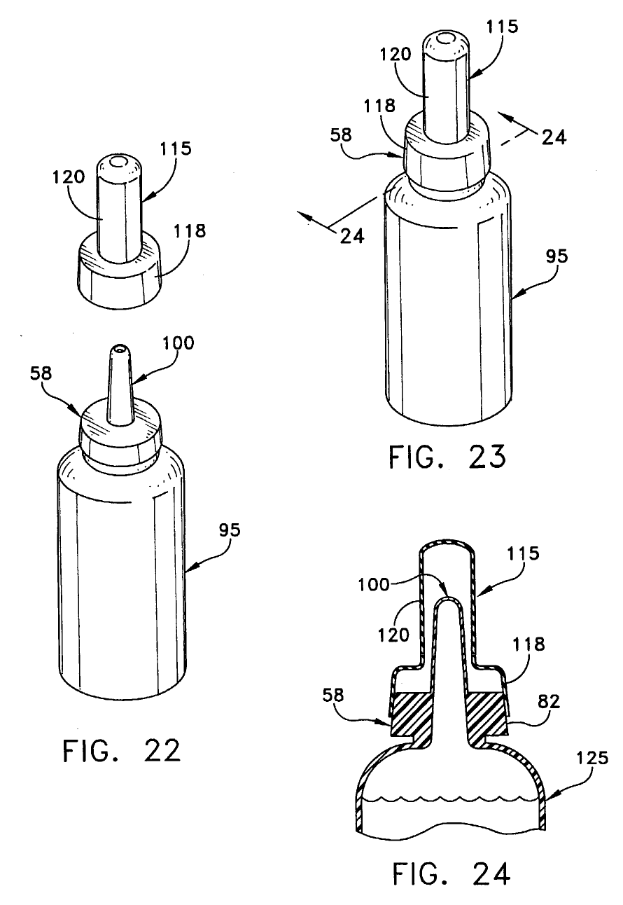

Referring to FIGS. 13-15, an alternative embodiment of the present invention comprises an eye drop container 125 comprising an integrally formed container-port housing 130 formed at approximately the same location as threads 98 on nozzle 100 of eye drop container 95. More particularly, container-port housing 130 includes a flange 135 and a plug 137, which are substantially similar to flange 80 and plug 82 of container-port housing 58. More particularly, plug 137 comprises a frusto-conical annular shoulder that projects radially outwardly from a lower portion of nozzle 100 and above flange 135. It will be understood that flange 135 may be omitted from eye drop container 125 without departing from the scope of the present invention (FIGS. 22-24). Advantageously, eye drop container 125 removes the step of assembling a separate container-port housing to the container, thus further simplifying the procedure for dispensing eye drops in accordance with the present invention.

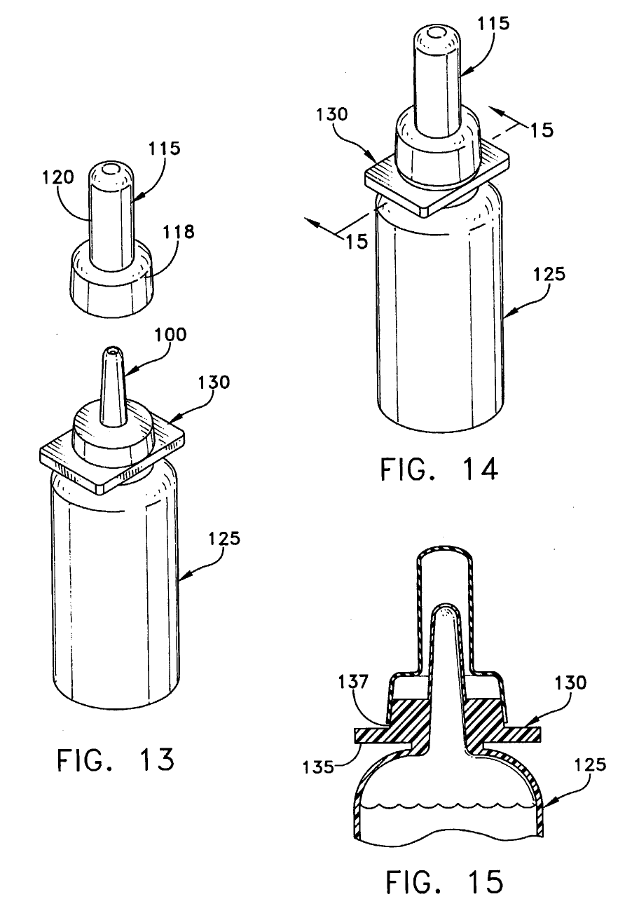

In a further embodiment of the present invention, a kit 150 may be provided to that allows for the use of device 5 with a number of different eye drop containers 95a,95b,95c, etc., each having a distinct thread pitch and diameter (FIG. 16). In such a kit, a plurality of container-port housings 58a,58b,58c, etc., each having a plug 82 with a through-bore 85 that is sized so as to releasably receive a portion of a particular eye drop container 95a,95b,95c. Advantageously, the different eye drop containers may be accommodated by providing a plurality of container-port housings 58a,58b,58c that each comprise a distinctly sized and threaded through-bore 85.

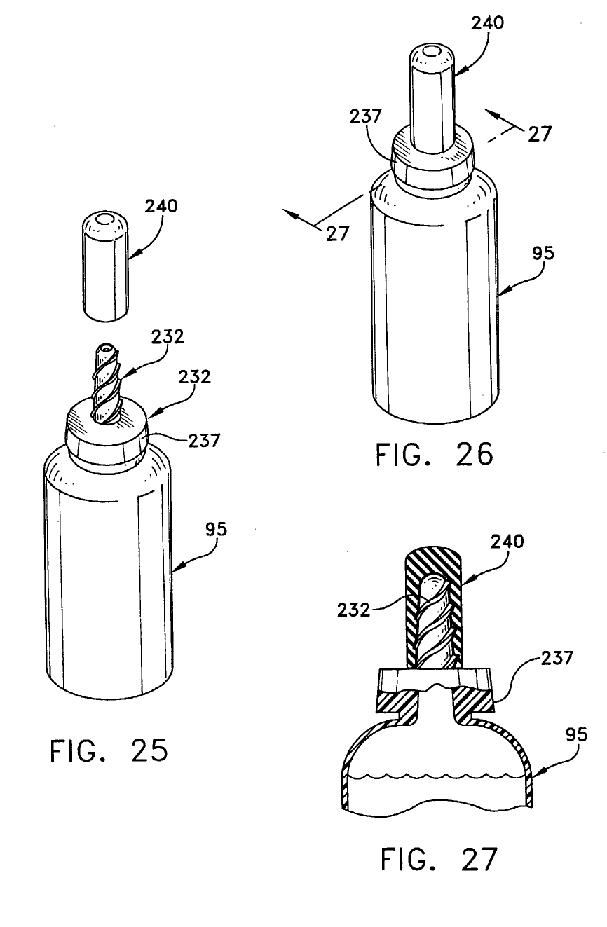

In another aspect of the invention, an eye drop container 195 comprises an integrally formed container-port housing 230 formed at a base portion of a externally threaded nozzle 232 (FIGS. 25-27). More particularly, container-port housing 230 includes a plug 237, which is substantially similar to plug 82 of container-port housing 58. More particularly, plug 237 comprises a frusto-conical annular shoulder that projects radially outwardly from a lower portion of nozzle 232. Nozzle 232 is threaded along a portion of its length, above plug 237. In this way, a correspondingly threaded cap 240 may be fitted to nozzle 232 after use for even more convenient and safe storage.

Advantages of the Invention

Numerous advantages are obtained by employing the present invention.

More specifically, an apparatus for positioning an eye drop container adjacent to an eye is provided which avoids all of the aforementioned problems associated with prior art devices.

In addition, an apparatus for positioning an eye drop container adjacent to an eye is provided which comprises a two piece adapter/holder that allows for easier assembly and handling of the eye drop container.

Furthermore, an apparatus for positioning an eye drop container adjacent to an eye is provided which allows for the use of multiple eye drop containers per eye without the need for further assembly (pre-assembled: socket housing 55 to frame 12) and which provides for quick change between eye drop containers.

Also, an apparatus for positioning an eye drop container adjacent to an eye is provided which allows for the use of the same eye drop container for both eyes through the successive repositioning of container-port housing 58 in socket housing 55 for each eye.

Furthermore, an apparatus for positioning an eye drop container adjacent to an eye is provided which does not require the use of a stand to prevent leakage from the bottle during storage since the eye drop container may be easily removed and capped.

Also, an apparatus for positioning an eye drop container adjacent to an eye is provided which does not require intricate assembly procedures prior to use.

In addition, an apparatus for positioning an eye drop container adjacent to an eye is provided in which the eye drop container may remain vertical after removal from socket housing 55.

Furthermore, an apparatus for positioning an eye drop container adjacent to an eye is provided in which container-port housing 58 remains assembled to the eye drop container after application of the eye drops and during routine storage.

Also, an apparatus for positioning an eye drop container adjacent to an eye is provided which the eye drop container position during application of drops is not determined by threads, e.g., (non-round-Zalatan® container).

In addition, an apparatus for positioning an eye drop container adjacent to an eye is provided having a cap that may be placed over the eye drop container and container-port housing 58 for easy storage.

It is to be understood that the present invention is by no means limited only to the particular constructions herein disclosed and shown in the drawings, but also comprises any modifications or equivalents within the scope of the claims.

What is claimed is:

1. An apparatus for positioning an eye drop container adjacent to an eye, comprising:
a frame having at least one guide that is positionable adjacent to an eye;
at least one socket housing mounted to said at least one guide so as to be slidable relative to said eye, and having a receptacle; and
a container-port housing having a plug with a bore therethrough to releasably receive a portion of an eye drop container so that when said plug is received within said receptacle, a second portion of said eye drop container is positioned adjacent to said eye.

2. Apparatus according to claim 1 wherein said socket housing includes a pair of spaced-apart cantilevered arms that project outwardly from an interface plate so as to slidingly engage a portion of said guide.

3. Apparatus according to claim 2 wherein each of said cantilevered arms comprises a guide slot defined on an outer surface, said guide slot being curved so as to be complementary to a corresponding curved portion of said guide.

4. Apparatus according to claim 1 wherein said container-port housing includes a flange with said plug projecting outwardly from a surface and a thread defined on a surface that defines said bore.

5. Apparatus according to claim 1 wherein said plug comprises a frusto-conical cross-sectional shape.

6. Apparatus according to claim 4 further comprising an eye drop container having a threaded first portion and wherein said threaded bore of said container-port housing extends the length of said plug so as to releasably engage said threaded first portion.

7. A device according to claim 6 further comprising a cap for sealing said eye drop container when engaged with said container-port housing.

8. Apparatus according to claim 1 wherein said socket housing is releasably and selectively slidable along a substantially arcuate path proximate said eye.

9. Apparatus according to claim 2 wherein said cantilevered arms comprise a chamfered surface formed on a portion of an outer surface that extends from said guide slot to a free end of each of said cantilevered arms.

10. Apparatus according to claim 1 wherein said frame comprises an eyeglass-type structure comprising a bridge portion.

11. Apparatus according to claim 10 wherein said socket housing is selectively positionable on said guide between a first position located a first distance from said bridge portion to at least one second position located closer to said bridge portion.

12. Apparatus according to claim 1 wherein said guide is integral with said frame.

13. A kit for forming multiple apparatus for positioning an eye drop container adjacent to an eye, comprising:
a frame having at least one guide that is positionable adjacent to an eye;
at least one socket housing mounted to said at least one guide so as to be slidable relative to said eye, and having a receptacle; and
a plurality of container-port housings each having a plug with a bore therethrough wherein each bore is sized so as to releasably receive a portion of an eye drop container so that when said plug is received within said receptacle, a second portion of said eye drop container is positioned adjacent to said eye.

14. Apparatus according to claim 13 wherein each of said plurality of container-port housings comprises a distinct threaded through-bore.

15. An apparatus for positioning an eye drop container adjacent to an eye, comprising:
a frame that is supportable upon a face, said frame including at least one guide that is positionable adjacent to an eye and comprises spaced-apart sidewalls forming a pair of spaced apart, opposed edges;
at least one socket housing releasably mounted to said spaced-apart sidewalls and between said edges so as to be slidable relative to said eye; and
a container-port housing releasably mounted to said socket housing.

16. Apparatus according to claim 15 wherein said socket housing includes a pair of spaced-apart cantilevered arms that project outwardly from an interface plate so as to slidingly engage said edges.

17. Apparatus according to claim 16 wherein said edges comprise a convex curvature.

18. Apparatus according to claim 17 wherein each of said cantilevered arms comprises a guide slot defined on an outer surface, said guide slot being curved so as to be complementary to at least one of said edges.

19. Apparatus according to claim 17 wherein said container-port housing includes a flange having a plug that projects outwardly from a surface and includes a threaded through-bore defined through a central portion of said flange.

20. Apparatus according to claim 19 wherein said plug comprises a frusto-conical cross-sectional shape.

21. Apparatus according to claim 20 further comprising an eye drop container having a threaded portion wherein said threaded through-bore of said container-port housing extends the length of said plug and is dimensioned to releasably engage said threaded portion of said eye drop container.

22. Apparatus according to claim 20 wherein said cantilevered arms comprise a chamfered surface formed on a portion of an outer surface that extends from said guide slot to a free end of each of said cantilevered arms.

23. Apparatus according to claim 22 wherein said socket housing is releasably and selectively slidable along a substantially arcuate path proximate said eye.

24. Apparatus according to claim 15 wherein said frame comprises an eyeglass-type structure comprising a bridge portion.

25. Apparatus according to claim 24 wherein said socket housing is selectively positionable on said guide between a first position located a first distance from said bridge portion to at least one second position located closer to said bridge portion.

26. Apparatus according to claim 25 wherein said guide is integral with said frame.

27. A device according to claim 21 further comprising a cap for sealing said eye drop container when engaged with said container-port housing.

28. A system for positioning an eye drop container adjacent to an eye, comprising:
a frame having at least one guide that is positionable adjacent to an eye;
at least one socket housing mounted to said at least one guide so as to be slidable relative to said eye, and having a receptacle; and
an eye drop container having nozzle at one end and a shoulder that projects radially outwardly from a lower portion of said nozzle so that when said shoulder of said eye drop container is received within said receptacle, a portion of said nozzle is positioned adjacent to said eye.

29. A device according to claim 28 further comprising a cap for sealing said eye drop container when engaged with said shoulder.

30. A device according to claim 29 wherein said cap and said nozzle threadingly engage one another.

31. A device according to claim 28 wherein said shoulder comprises a frusto-conical cross-sectional shape.

32. An apparatus for positioning an eye drop container adjacent to an eye, comprising:
a frame having at least one guide that is positionable adjacent to an eye;
at least one socket housing mounted to said at least one guide so as to be slidable relative to said eye, and having a receptacle; and
a container-port housing having a plug with a slot defined therethrough to releasably receive a portion of an eye drop container so that when said plug is received within said receptacle, a second portion of said eye drop container is positioned adjacent to said eye.
